(19) United States
(12) Patent Application Publication
(10) Pub. No.: US 2011/0064348 A1
(43) Pub. Date: Mar. 17, 2011

(54) Roller Bearing

(76) Inventors: Werner Jacob, Frankfurt (DE); Martin D. Jacob, Cremlingen (DE)

(21) Appl. No.: 12/446,295

(22) PCT Filed: Feb. 11, 2008
(86) PCT No.: PCT/EP08/01006

§ 371 Date: Oct. 11, 2010

(30) Foreign Application Priority Data
Feb. 23, 2007 (DE) 102007009436.3
May 4, 2007 (DE) 102007021523.3

(51) Int. Cl. F16C 33/36

(52) U.S. Cl. 384/568

(57) ABSTRACT

The invention relates to a roller bearing comprising an inner ring that defines a bearing axis and an outer ring, said rings forming bearing races. Roller bodies are provided between the races, the geometry of the roller bodies and the races being adapted to one another in such a way that the roller bearing forms a barrel roller bearing that can be stressed on one side. Preferably the roller bodies lie against two osculation contact points lying outside the self-locking region on the races of the inner and outer rings.

### CROSS REFERENCE TO RELATED APPLICATIONS

This application claims priority under 35 U.S.C. 119 of German application serial Nos. 10 DE 2007 009 436.3 filed Feb. 23, 2007 (Feb. 23, 2007) and DE 10 2007 021 523.3 filed May 4, 2007 (Apr. 5, 2007) and corresponding filed and WO 2008/101606 A2 (international publication date Aug. 28, 2008 (Aug. 28, 2008), the contents of which are fully incorporated herein by reference.

### BACKGROUND

The invention relates to a roller bearing with an inner ring defining the bearing axis, and an outer ring, said rings forming corresponding bearing races, and several roller bodies placed in between, with the roller bearing being implemented as a tapered barrel roller bearing that can be stressed on one side.

Conical (tapered) roller bearings are commonly used to support combined radial and axial loads. Conical roller bearings have the disadvantage that they are very susceptible to edge stresses, which are caused by misalignment of the conical roller bearing, causing very high stress levels at the opposing edges of the conical rollers. Furthermore, when axially loaded, conical roller bearings demonstrate high friction losses on one front face of the conical rollers, a fact that is also considered to be of disadvantage.

Furthermore it is known to deploy barrel bearings that are particularly well-suited to support heavy radial loads, but support only low axial loads. From the DE 39 04 456 C2 a pivoting bearing is known, utilizing a mostly barrel-shaped roller body with an outer surface that has a cylindrical segment and two radial load-bearing segments formed by two radii around different center points. The race on the inner ring and the race on the outer ring are designed as circular arcs in the longitudinal section, allowing misalignment between the inner and outer ring of the pivoting bearing. Contrary to a tapered bearing, the pivoting bearing is not suited to support combined loads.

To support combined loads, a tapered double ball bearing was suggested, e.g. EP 1 105 662 B2, a design that largely avoids the abovementioned disadvantages. Such tapered double ball bearings are being utilized in the automobile industry with great success. Due to their limited load capacities though, their application in trucks, agricultural vehicles, buses, or shipbuilding is quite limited. Furthermore, there is a demand to further minimize friction losses of such bearings.

The invention is based on the task of providing a roller bearing of the abovementioned design that is also capable to support heavy combined loads and that provides minimal friction while demonstrating low edge sensitivity.

This task has been largely solved, with this invention, by using a roller bearing with an inner ring defining the bearing axis, and an outer ring, each forming corresponding races, and several roller bodies placed in between, with the geometry of the roller bodies and the races being shaped such that the bearing forms a tapered barrel roller bearing that can be stressed on one side, with the barrel-shaped roller bodies touching the inner and outer rings at two osculation contact points each. At the same time it is preferred to keep the osculation contact points outside of the self-locking range. This can be achieved by placing the osculation contact points with an offset onto an osculation arc, for example of the barrel rollers to an angle greater than the self-locking area, thus for example approximately 7 degrees, with respect to the center plane, which is placed perpendicular to the rotation axis of the barrel roller.

With this invention, a tapered barrel roller bearing is defined as a bearing where the rotation axes of the rollers are placed at an arbitrary angle relative to the bearing axis itself. The tapered barrel roller bearing, based on the invention, combines the advantages of a barrel roller bearing, having low edge sensitivity as well as a small risk of friction losses on collars when axially loaded, with the advantages of conical (tapered) roller bearings, providing large load capacities under combined loads.

Particularly low friction can be achieved when the contact tangents at the osculation contact points on the race on the inner ring meet the contact tangents at the osculation contact points on the race of the outer ring in a single point on the bearing axis. This is achieved, based on the invention, by designing the roller bodies as conical (tapered) barrel rollers. In other words, the distance between the osculation contact points of the conical rollers with the inner ring and the outer ring on the side of the conical roller that is closer to the bearing axis is smaller than the distance between the osculation contact points of the conical rollers with the inner ring and the outer ring on the side of the conical roller that is farther from the bearing axis. In this configuration, in which the contact tangents meet on a single point on the bearing axis, the conical barrel roller bodies perform pure rolling movements and no sliding (drilling) movement.

According to a preferred version of the invention, the outer surface of the roller body is formed as a circular arc of constant radius in the longitudinal cross section. Thus, the surface of the barrel is not designed with a central cylindrical segment and two circular arcs with different centers of curvature forming two osculation contact points, but rather by a single circular arc. The center of the circle defining the surface of the roller body is not placed on the plane that is perpendicular to the rotation axis of the roller body.

The center of the circle defining the surface of the roller body is rather placed on the plane that is perpendicular to the contact point tangents at the osculation contact points on the inner and outer race of the inner and the outer ring.

It is preferred that the races on the inner and outer ring are formed by two osculation areas, each of the osculation areas being defined by a circular arc with constant radius in the longitudinal cross section along the bearing axis. The two arcs, defining the osculation areas, have then arc center points that are distant from each other and that are different from the center of the arc defining the surface of the roller body.

According to the invention, the radius of the circular arc defining the surface of the roller body is smaller than the radius defining the osculation areas.

The tapered barrel roller bearing, according to the invention, exhibits therefore four osculation areas, two of which are placed on the outer ring, and two of which are placed on the inner ring, with each of the four osculation areas having an osculation contact point, at which a roller body, preferably formed as a conical barrel, touches the inner or outer ring. When considering the complete inner and outer ring, each of the four osculation areas define a circumferential line on which the osculation contact points with the roller body are placed.

To support axial forces of the roller bodies without a possibility of self-locking, each of the races is designed with a relief groove in the self-locking area between the two osculation areas. This groove, covering the self-locking area, prevents the roller bodies from coming into contact with the race in the self-locking area.

According to the invention, the roller bodies are aligned parallel to each other and at a well-defined angle relative to the bearing axis using a cage. To this end, the cage can be held by a groove-like cage guide on the inner ring of the roller bearing.

The cage can be provided with window openings to provide space for the roller bodies and with tabs so that the roller bodies are held in the cage while being able to rotate. The cage is designed in a manner that minimizes friction losses between the cage and the roller bodies.

It is preferred to use roller bodies with a diameter to length ratio less than approximately 1:1.5, specifically less than about 1:2. In other words, the length of the roller bodies should increase compared to the diameter of the roller bodies.

The roller bearing, according to the invention, can also be designed as a double row bearing. For example, a double row tapered barrel roller bearing is suitable for the use in a wheel set for rail vehicles, in which the conical barrel rollers are arranged in an O configuration. Preferably, the inner or outer ring of double row tapered barrel roller bearings is designed as a single piece. The conical barrel rollers can then be placed into a cage, preferable made from polymers.

The invention covers furthermore a bearing configuration of at least two separate (spaced from each other) and axially pre-stressed roller bearings of the above design. These roller bearings can be arranged, for example, in an O or X configuration. According to the invention, the roller bearing is suitable for a variety of applications. It can, for example, be deployed in automobiles, trucks, buses, as well as rail vehicles, agricultural machinery, and construction machinery. A potential application is, for example, a transmission, particularly a transfer gearbox in a vehicle, that employs at least one bearing of the abovementioned design. A particularly preferred design calls for a gearbox with two separate spaced from each other bearings of the abovementioned design that are in an axially pre-stressed configuration. The invention is not limited to the deployment in one of the abovementioned applications; rather, the bearings described in this invention are suitable for a wide variety of applications, especially when large combined loads are required with a minimum of friction loss.

These as well as other advantages of various aspects of the present invention will become apparent to those of ordinary skill in the art by reading the following detailed description, with appropriate reference to the accompanying drawings.

The invention will be described in detail by means of different designs and with reference to the figure. It shows:

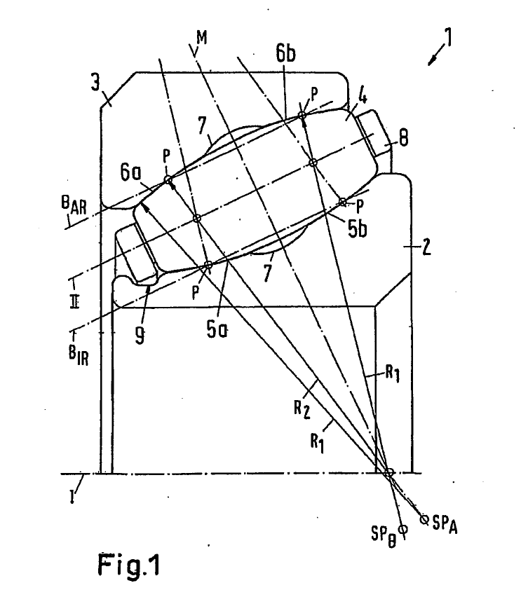

FIG. 1: cross section of a roller bearing of the first design based on the invention

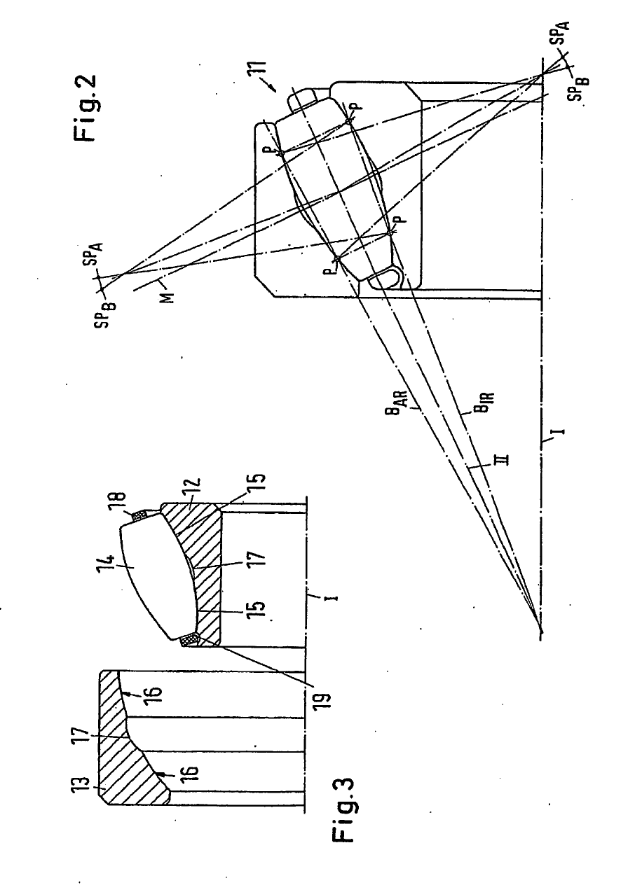

FIG. 2: cross section of a roller bearing of the second design based on the invention

FIG. 3: cross section of a roller bearing according to FIG. 2, with the outer ring removed from the inner ring

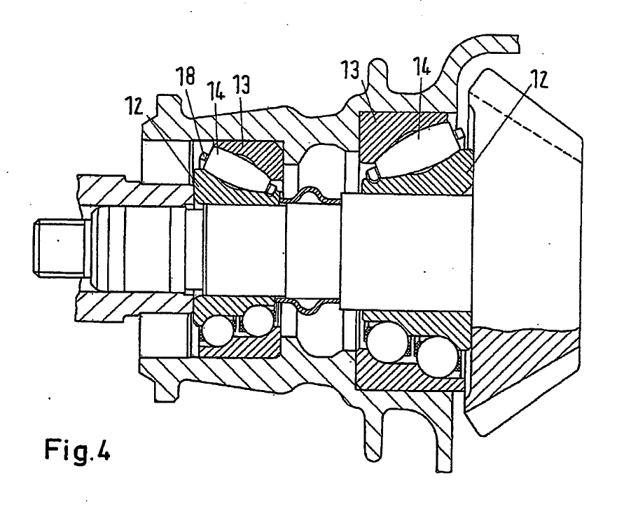

FIG. 4: an application example for the roller bearing according to FIG. 2, and

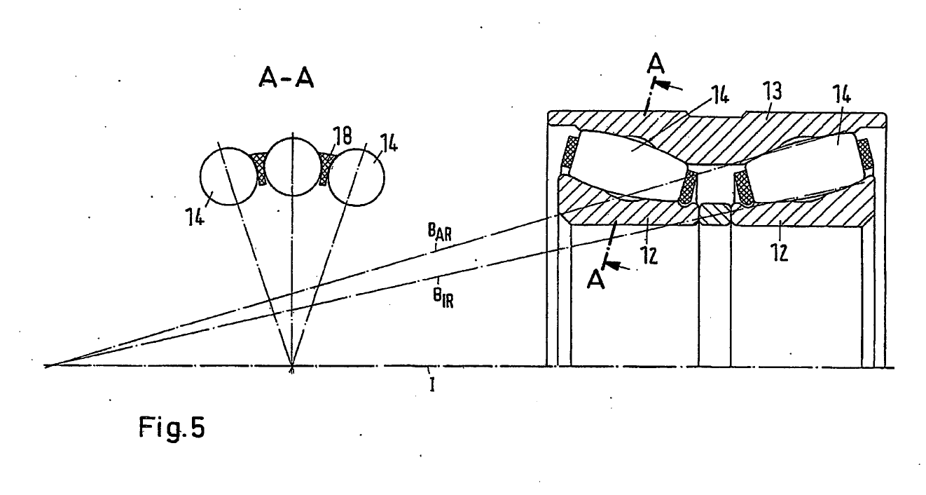

FIG. 5: a cross section of a double row roller bearing of another design based on the invention

FIG. 1 shows a tapered barrel roller bearing 1 that can be stressed on one side, which is composed of an inner ring 2, and outer ring 3, and a roller body 4 that is placed between the inner ring 2 and outer ring 3. The inner ring 2 defines the bearing axis I, on which the inner ring 2 and the outer ring 3 are placed (formed) preferably rotation-symmetrically. The rotational axes II, around which the roller bodies 4 rotate during operation, are tilted in relation to the bearing axis I.

On the inner ring 2 and the outer ring 3 are races that are opposed to each other, on which the roller bodies 4 are rollingly guided. The race on the inner ring 2 is divided into to osculation areas 5a and 5b, and the race on the other ring 3 is divided into two osculation areas 6a and 6b. The osculation areas are formed by circular arcs in the longitudinal section according to FIG. 1, both defined by an identical radius R₁. The centers SP_{A} and SP_{B} of the circular arcs are offset from each other and are outside of the plane M being perpendicular to the rotational axis II of roller body 4.

On each race there is a relief groove 7 in the self-locking area between the osculation areas 5a, 5b, and 6a, 6b. This ensures that the roller bodies won't be able to touch the races in the self-locking areas.

The barrel-shaped roller body 4 is designed with a surface that serves as a contact with the races on the inner ring 2 and the outer ring 3, with this surface being defined by a circular arc in the longitudinal section of FIG. 1 as well. The center SP of the circular arc is placed on the center plane M and the bearing axis I. The radius R₂ for the outer surface is smaller than the radius R₁, which describes the arc of the osculation areas.

In this manner, an osculation contact point P is formed in each of the osculation areas 5a, 5b and 6a, 6b, at which each of the roller bodies 4 makes contact with the inner ring 2 and the outer ring 3. When drawing a contact tangent through the two osculation contact points on the inner ring 2 and the two osculation contact points on the outer ring 3 (lines B_{I}R and B_{AR} in FIG. 1), the contact tangents for the barrel roller body 4 according to FIG. 1 run parallel to each other, and run parallel to the rotational axis II as well.

The roller bodies 4 in the design shown in FIG. 1 are placed into a cage 8 to hold them parallel to each other and in a well-defined orientation to the bearing axis I. To this effect, the cage is guided by a groove-like cage guide 9 in the inner ring 2.

FIG. 2 illustrates a second design based on the invention, where the components shown in FIG. 2 that are of identical design compared to FIG. 1 are prefixed with “1”.

The roller bearing 11, according to FIG. 2, is designed as a tapered conical barrel roller bearing, where the roller bodies 14 are not simply barrel shaped but rather conical barrels. The outer surface of the roller bodies 14 is again defined by a circular arc in the longitudinal section shown in FIG. 2, with a constant radius R₂ around a center that is placed on the bearing axis I.

Also, the osculation areas 15a, 15b, and 16a, 16b on the races on the inner ring 12 and the outer ring 13 are defined again by circular arcs with constant radius and centers that are offset from each other.

Due to the conical shape of the roller bodies 14, the contact tangents B_{IR} and B_{AR} at the osculation contact points P in FIG. 2 are not running parallel to the rotational axis II of the roller bodies 14, but rather meet the rotational axis II in a point on the bearing axis I. This configuration assures that the conical barrel rollers 14 are operating in a pure rolling motion, avoiding the corresponding friction losses of a sliding movement.

FIG. 3 illustrates that the conical barrel rollers 14 of the design shown in FIG. 2 are guided on the inner ring 12 in a cage 18, while the outer ring 13 can be removed from the conical barrel rollers 14.

The upper half of FIG. 4 illustrates a design of a tapered conical barrel roller bearing 11 according to FIG. 2 with an arrangement of two roller bearings 11 in a transfer gearbox. The bottom half illustrates a common bearing design with tapered double row ball bearings.

The two roller bearings 11 in this design are axially pre-stressed, i.e. in the direction of bearing axis I. In the design according to FIG. 4, the two roller bearings 11 are arranged in an O configuration. If necessary, it is also possible to arrange roller bearings 1 and 11 in an X configuration.

Another design based on this invention is illustrated in FIG. 5, showing a double row tapered conical barrel roller bearing. This double row design, which is particularly suited for the application in wheel sets for rail vehicles, is designed in a way that the conical barrel rollers are arranged in an O configuration. In other cases, an alternative X configuration may be more suitable.

While the illustrated design shows a separate inner ring 12 for each conical barrel roller 14 that is supported by the second inner ring 12 using an intermediate bushing, the outer ring 13 is designed as a single outer ring for both conical barrel rollers. An alternative design implements the inner ring as a single ring as well. The conical rollers 14 are preferably contained in a polymer cage 18.

Exemplary embodiments of the present invention have been disclosed. Those skilled in the art will understand, however, that changes and modification may be made to these embodiments without departing from the true scope and spirit of the present invention, which is defined by the claims.

### LEGEND

1,11 Roller bearings
2,12 Inner ring
3,13 Outer ring
4,14 Roller bodies
5a,5b,6a,6b Osculation areas
15,16 Osculation areas
7,17 Relief groove
8,18 Cage
9,19 Cage guide
I Bearing axis
II Rotational axis
B_{IR} Contact tangent for the inner ring
B_{AR} Contact tangent for the outer ring
P Osculation contact points
M Center plane
SP_{A},SP_{B} Center of the circular arc for osculation area
R₁ Radius of the circular arc forming the osculation area
R₂ Radius of the circular arc forming the roller body surface

1. Roller bearing comprising an inner ring (2, 12) that defines a bearing axis (I) and an outer ring (3, 13), said rings forming bearing races wherein roller bodies (4, 14) are provided between the races, the geometry of the roller bodies (4,14) and the races being adapted to one another in such a way that the roller bearing (1,11) forms a barrel roller bearing that can be stressed on one side, with the roller bodies being in contact with two osculation contact points (P) on the races on the inner ring (2,12) and the outer ring (3, 13), respectively, the osculation contact point (P) lying preferably outside the self-locking region.

2. Roller bearing according to claim 1 characterized by the fact that the roller bodies are formed as conical barrel rollers (14) so that the contact tangents (B_{IR}) at the osculation contact points (P) on the race on the inner ring (12) and the contact tangents (B_{AR}) at the osculation contact points (P) on the race on the outer ring (13) meet on a single point on the bearing axis (I).

3. Roller bearing according to claim 1, characterized by the fact that the outer surface of the roller body (4,14) is defined by a circular arc with constant radius (R₂) across the longitudinal section along the bearing axis (I).

4. Roller bearing according to claim 1, characterized by the fact that the races on the inner ring (2,12) and the outer ring (3,13) are shaped by two osculation areas each (5a,5b,6a,6b,15a,15b,16a,16b), which are formed by a circular arc with constant radius (R₁) in the longitudinal cross section along the bearing axis (I).

5. Roller bearing according to claim 3, characterized by the fact that the radius (R₂) of the circular arc forming the outer surface of the roller bodies (4,14) is smaller than the radius (R₁) of the circular arc defining the osculation areas.

6. Roller bearing according to claim 4, characterized by the fact that each of the four osculation areas (5a,5b,6a,6b,15a,15b,16a,16b) has an osculation contact point (P), at which the roller bodies (4,14) make contact with the inner ring (2,12) or the outer ring (3,13).

7. Roller bearing according to claim 4, characterized by the fact that a relief groove (7,17) is provided on each race in the self-locking area between the osculation contact points (5a,5b,6a,6b,15a,15b,16a,16b).

8. Roller bearing according to claim 1, characterized by the fact that the roller bodies (4,14) are placed into a cage (8,18) to hold them parallel to each other and in a well-defined orientation to the bearing axis.

9. Roller bearing according to claim 8, characterized by the fact that the cage (8,18) is held in a groove-like cage guide (9,19) on the inner ring (2,12).

10. Roller bearing according to claim 8, characterized by the fact that the cage (8,18) is provided with window openings to hold the roller bodies (4,14) and with tabs so that the roller bodies (4,14) are held in the cage (8,18) while being able to rotate.

11. Roller bearing according to claim 1, characterized by the fact that the ratio of diameter to length of the roller bodies (4,14) is less than about 1:1.5, and specifically less than about 1:2.

12. Roller bearing according to claim 1 that is formed as a double row bearing.

13. Roller bearings according to claim 12, characterized by the fact that the outer ring (3,13) or the inner ring (2,12) are formed as a single piece.

14. Bearing configuration with at least two axially pre-stressed roller bearings (1,11) according to claim 1, which bearings are spaced from each other.

15. Gearbox, in particular transfer gearbox in a vehicle, with at least one roller bearing (1,11) according to claim 1.
